(19) United States
(12) Patent Application Publication
(10) Pub. No.: US 2003/0007243 A1
(43) Pub. Date: Jan. 9, 2003

(54) Method for manufacturing 3D image display body

(76) Inventors: Kazuo Maeda, Joetsu-shi (JP); Yoshihiro Yoshihara, Nakakubiki-gun (JP)

Correspondence Address: Gerow D. Brill, Reveo, Inc., 85 Executive Blvd., Elmsford, NY, 10523, US

(21) Appl. No.: 09/878,491

(22) Filed: Jun. 11, 2001

(51) Int. Cl. G02B 27/22

(52) U.S. Cl. 359/462; 359/900

(57) ABSTRACT

The present invention provides a method for manufacturing a 3D image display body which is used to display 3D images in which right-eye image display parts a and left-eye image display parts b are mixed, the method having a phase-difference film that is disposed on a transparent support with an adhesive agent interposed. Specified portions of the above-mentioned phase-difference film are then cut away by means of an ultra-hard blade, so that a plurality of grooves that extend from one side of the phase-difference film to the other side are formed side by side in the phase-difference film. A display member is then superimposed on or bonded to the phase-difference film.

### BACKGROUND OF THE INVENTION

The present invention relates to a method for manufacturing a 3D image display body that is used to display 3D images.

3D image display devices such as that disclosed in U.S. Pat No. 5,327,285 ('285) by Faris issued on Jul. 5, 1994 and incorporated herein by reference have been proposed in the past. In this 3D image display device 10, as is shown in FIG. 1, a film 12 in which right-eye image display parts a and left-eye image display parts b are alternately disposed side by side is bonded to the surface of a liquid crystal member 14. When the light emitted by the aforementioned liquid crystal member 12 is controlled so that a specified image is displayed, a right-eye image is displayed from the right-eye image display parts a, and a left-eye image is displayed from the left-eye image display parts b. Furthermore, since the device 10 is constructed so that the direction of vibration of the polarized light constituting the right-eye image from the right-eye image display parts a has an angle of 90° relative to the direction of vibration of the polarized light constituting the left-eye image from the left-eye image display parts b (i.e., since the device is constructed so that (for example) the x component of the right-eye image consisting of two components x and y has a phase difference of 180° (π) with respect to the x component of the left-eye image which similarly consists of two components x and y), the observer can experience the sensation of observing a three-dimensional image when the aforementioned image is viewed using polarizing eyeglasses consisting of a polarizer-equipped right-eye lens that transmits only the right-eye image and a polarizer-equipped left-eye lens that transmits only the left-eye image.

As has been disclosed earlier in FIG. 2 of the '285 patent, such a film 12 in which the aforementioned right-eye image display parts a and left-eye image display parts b are alternately disposed side by side is manufactured by a chemical treatment method in which a polarizing film formed by laminating a TAC film (triacetylcellulose film) and an iodine-treated drawn PVA film (polyvinyl alcohol film) is coated with a photoresist, after which specified portions of the film are exposed, and these portions are then treated with a potassium hydroxide solution, so that the property that the drawn PVA film has of being able to rotate the direction of vibration of light in a specified wavelength region while maintaining the linearly polarized state of the light “as is” (phase-difference function) is eliminated, or by a physical treatment method in which specified portions of the above-mentioned polarizing film are removed by means of a diamond cutter, so that the above-mentioned property is eliminated only in these portions, etc.

However, the former chemical treatment method is a method in which the above-mentioned property of the drawn PVA film is eliminated by treatment with a chemical solution (potassium hydroxide solution), and thus suffers from a drawback in that the boundary between the portions in which the above-mentioned property is eliminated and the portions in which the above-mentioned property is not eliminated is unclear. In this regard, the latter physical treatment method does not suffer from such a drawback, and is therefore superior to the chemical treatment method. However, the above-mentioned method in which a diamond cutter is used suffers from the following drawbacks.

The diamond cutter is formed by bonding a diamond powder to the circumferential edge of a rotating metal blade by means of an adhesive agent, and when this cutter is caused to contact the object that is being cut, the adhesive agent is removed as a result of frictional heat, etc.. The diamond powder embedded in the adhesive agent is exposed, and thus exhibits a cutting effect.

However, when the object that is being cut consists of a synthetic resin material, this synthetic resin material melts during cutting and adheres to the diamond powder. Furthermore, the removal of the adhesive agent may be inhibited, so that the exposure of the diamond powder is suppressed, thus causing a drop in the cutting capacity.

Accordingly, in cases where a diamond cutter is used to form grooves in the above-mentioned polarizing film, the productivity is markedly inferior.

### SUMMARY OF THE INVENTION

The present invention provides a method for efficiently manufacturing a 3D image display body in which right-eye image display parts a and left-eye image display parts b are mixed, and which has a good function. The object of the present invention is to allow the easy production of a film which has right-eye image display parts a and left-eye image display parts b that are superior in terms of optical characteristics.

### BRIEF DESCRIPTION OF THE DRAWINGS

The present invention is described below with reference to the attached figures wherein:

FIG. 1 is an explanatory diagram of a conventional 3D image display device;

FIG. 2 is a structural explanatory diagram of an embodiment of the present invention; and

FIG. 3 is a front view of the ultra-hard blade used in the present embodiment.

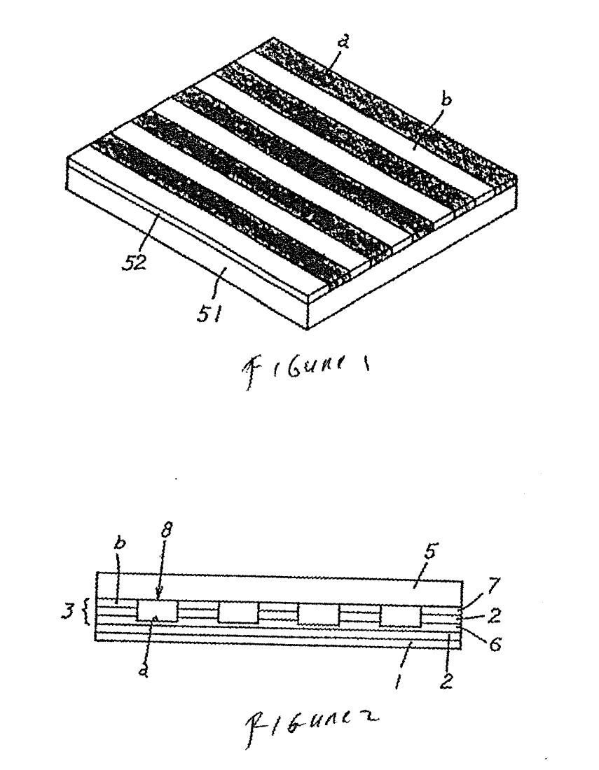

### DETAILED DESCRIPTION OF THE INVENTION

The present invention relates to a method for manufacturing a 3D image display body 20 which is used to display 3D images in which right-eye image display parts a and left-eye image display parts b are mixed. The 3D image display body 20 manufacturing method includes a phase-difference film 30 disposed on a transparent support 22 with an adhesive agent 24 interposed. Specified portions of the above-mentioned phase-difference film are then cut away by means of an ultra-hard blade 24, as shown in FIG. 3, so that a plurality of grooves 26 that extend from one side of the phase-difference film 30 to the other are formed side by side in the phase-difference film 30. A display member 28 is then superimposed on or bonded to the phase-difference film 30.

Furthermore, the present invention also relates to a method for manufacturing a 3D image display body 20 which is used to display 3D images in which right-eye image display parts a and left-eye image display parts b are mixed. The 3D image display body 20 manufacturing method includes a laminated phase-difference film 30 formed by laminating a TAC film 32 or CAB film, etc., that does not possess birefringence and a polycarbonate film 34 or drawn PVA film, etc., that possesses birefringence is disposed on a transparent support 22 with an adhesive agent 36 interposed so that the TAC film 32, etc., is located on the side of the adhesive agent 36. The specified portions of the polycarbonate film 34, etc., in this laminated phase-difference film 30 are then cut away by means of an ultra-hard blade 24, so that a plurality of grooves 26 which extend from one side of the polycarbonate film, etc, to the other are formed side by side in the polycarbonate film 34 etc. A display member 28 is then superimposed on or bonded to the polycarbonate film 34.

The present invention also relates to a method for manufacturing a 3D image display body 20 additionally includes in the 3D image display body manufacturing method grooves 26 formed by removal of the film by means of an ultra-hard blade 24 that are filled with an appropriate synthetic resin.

A plurality of grooves 26 which extend from one side of the phase-difference film to the other are formed in the phase-difference film 30 by cutting away specified portions of the phase-difference film 30 by means of an ultra-hard blade 24. Accordingly, since no phase-difference film is present in these groove parts, the property that the phase-difference film has of being able to rotate the direction of vibration of light in a specified wavelength region while maintaining the linearly polarized state of the light “as is” is naturally not exhibited. Consequently, a film is obtained in which the phase of the transmitted light is shifted 180° between the groove parts and the other parts.

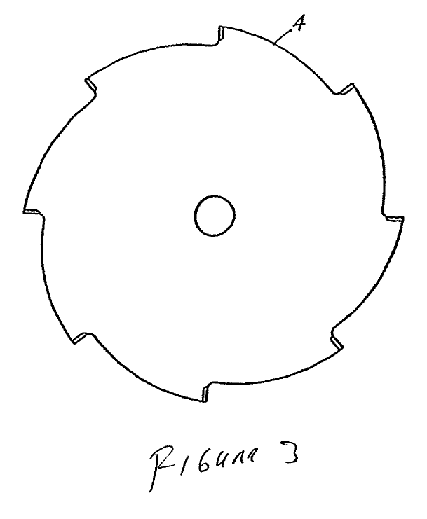

FIG. 2 illustrates an embodiment of the present invention, which will be described below in detail. A phase-difference film (i.e., a film which has the property of being able to rotate the direction of vibration of light in a specified wavelength region while maintaining the linearly polarized state of the light “as is;” also called a ½-wave plate) is laminated on the surface of a transparent support 22 (e.g., a glass plate or cellulose acetate butyrate (CAB) plate, etc., with a thickness of approximately 1 mm) with an adhesive agent 36 (e.g., an ultraviolet-curable resin) interposed, and the ultraviolet-curable resin is cured by means of ultraviolet light, so that a laminated phase-difference film 30 is formed. Furthermore, a glass plate that does not possess birefringence is most desirable as the support 22.

This laminated phase-difference film 30 has a construction in which a polycarbonate film 34 (thickness: approximately 70 μm) which has a phase-difference function (90° rotation in a case where the optical axis and direction of vibration are set at 45°) as a result of possessing birefringence is laminated on a TAC film 32 (thickness: approximately 80 μm) with an adhesive agent 36 (e.g., an ultraviolet-curable resin) interposed. It would also be possible to laminate a uniaxially drawn PVA film (thickness: approximately 70 μm) that has similar properties instead of the above-mentioned polycarbonate film 34.

A phase-difference film which uses a CAB film, etc., instead of the TAC film 32 of the set phase-difference film 30 may also be used. Any film in which a film that is substantially free of birefringence is laminated with a polycarbonate film 34 may be used as the above-mentioned laminated phase-difference film 30. Furthermore, in cases where a polycarbonate film 34 is used, the TAC film 32 or CAB film may be omitted. However, in cases where a drawn PVA film is used, the strength of this drawn PVA film is insufficient. Therefore, a TAC film 32 is required.

Next, specified portions of the polycarbonate film 34 of the above-mentioned laminated phase-difference film 30 are cut away using an ultra-hard blade 24 (saw blade) with the shape shown in FIG. 3, so that a plurality of parallel grooves 26 that extend from one side of the polycarbonate film 34 to the other are formed side by side in the surface of the polycarbonate film 34. These grooves 26 have a width of 200 μm, and the pitch of the grooves is also 200 μm.

Furthermore, the blade thickness of the ultra-hard blade 24 used in the present embodiment is 200 μm, the speed is 10,000 rpm, and the feed rate is 450 mm/sec.

In cases where a diamond cutter is used when the grooves 26 are thus formed in the polycarbonate film 34, favorable and efficient cutting is impossible (as was described above). however, when an ultra-hard blade 24 of the type employed in the present embodiment is used, the formation of the grooves 26 can be performed very efficiently.

Furthermore, Table 1 shows comparative data obtained in a cutting test comparing a case in which the grooves 26 were formed in the laminated phase-difference film 30 of the present embodiment using a diamond cutter, and a case in which the grooves 26 were formed using an ultra-hard blade 24.

TABLE 1
CUTTING TEST

| Feed rate mm/sec | | 10 | 20 | 30 | 400 |
|---|---|---|---|---|---|
| Diamond | Diamond powder No. 1700 | x | x | x | x |
| cutter | Diamond powder No. 1200 | ∘ | x | x | x |
| | Diamond powder No. 600 | ∘ | ∘ | x | x |
| | Diamond powder No. 320 | ∘ | ∘ | x | x |

| | | | | |
|---|---|---|---|---|
| Ultra-hard blade | ∘ | ∘ | ∘ | ∘ |

∘ Good cutting possible.
x Good cutting not possible.
cf. In the case of the diamond powder numbers, a larger number indicates a finer powder.

Parts where the aforementioned phase-difference function possessed by the polycarbonate film 34 is not exhibited are created by removing portions of the laminated phase-difference film 30 as described above. These portions, i.e., the bottoms of the grooves 26, consist of a TAC film 32. Accordingly, these bottom portions are used as (for example) right-eye image display parts a, while the remaining portions, i.e., the portions where the polycarbonate film 34 remains, are used as left-eye image display parts b.

Next, the above-mentioned grooves 26 are filled with an appropriate synthetic resin, e.g., an ultraviolet-curable resin. Furthermore, following this filling with a resin, a TAC film may be laminated on top. Such a TAC film is especially effective in cases where a drawn PVA film that has poor resistance to moist heat is used.

As a result of cutting and removal by means of an ultra-hard blade 24, fine recesses and projections are formed in the inside surfaces of the grooves 26. However, as a result of the filling of the grooves 26 with a resin, the aforementioned fine recesses and projections are embedded, and a flat surface is obtained, so that the optical characteristics are improved.

It has been confirmed that haze (degree of clouding) is greatly reduced in cases where the above-mentioned grooves 26 are filled with a resin compared to cases where the grooves 26 are not filled. In experiments, it was confirmed that in cases where the grooves are filled with a resin, the haze is reduced to half or less of the haze value seen in cases where the grooves are not embedded.

Next, a display member 28 which has a liquid crystal inside is superimposed by means of a magnet, or bonded by means of an appropriate adhesive agent, thus producing a 3D image display body.

Furthermore, the positions of the grooves 26, i.e., the positions of the right-eye image display parts a and left-eye image display parts b, are set so that these positions coincide with the pitch of the liquid crystal cells of the display member 28.

A film in which right-eye image display parts a and left-eye image display parts b are disposed side by side and which is superior in terms of optical characteristics can be obtained easily and efficiently by means of the above manufacturing method; accordingly, a 3D image display body which has a good function can also easily be obtained.

Furthermore, if the respective members are provided in the form of rolls in the above-mentioned manufacturing process, continuous manufacture is possible, so that the productivity of the 3D image display body is improved even further.

When the image from the 3D image display body manufactured as described above is viewed through polarizing eyeglasses consisting of a polarizer-equipped right-eye lens that transmits only the right-eye image from the right-eye image display parts a and a polarizer-equipped left-eye lens that transmits only the left-eye image from the left-eye image display parts b (i.e., an image that is composed of light that vibrates in a direction that is 90° perpendicular to the direction of vibration of the light composing the right-eye image), the observer can experience the sensation of viewing the above-mentioned image as a three-dimensional image.

In the present embodiment, as was described above, the right-eye image display parts a and the left-eye image display parts b are not formed by a chemical treatment method. For example, in cases where the right-eye image display parts a and left-eye image display parts b are formed by the aforementioned chemical treatment method, only a drawn PVA film that is relatively difficult to handle (i.e., which has a poor resistance to moist heat, etc.) can be used; an easy-to-handle polycarbonate film 34 cannot be used. In this regard, since the right-eye image display parts a and left-eye image display parts b are formed by the above-mentioned physical treatment method in the present embodiment, any type of material can be used to form the right-eye image display parts a and left-eye image display parts b. Accordingly, an easy-to-handle polycarbonate film 34 can also be used, so that the productivity is correspondingly improved.

In cases where a drawn PVA film is used, as was described above, the display member 28 is laminated after a TAC film that is used to prevent exposure of the drawn PVA film, is laminated on the upper surface. However, in the case of a polycarbonate film 34, such protection by means of a TAC film may be omitted, so that the productivity is improved in this respect as well in cases where a polycarbonate film 34 is used.

Furthermore, if a member that does not possess birefringence is used as the support 22, the TAC film 32 that is interposed between the polycarbonate film 34 or drawn PVA film and the support 22 becomes unnecessary. In this case, it is necessary to take care that no scratches are formed in the support 22 when the grooves 26 are formed in the polycarbonate film 34 by means of the ultra-hard blade 24. The thickness of the adhesive agent between the support 22 and the polycarbonate film 34 is set with this point taken into account (in this case, the adhesive agent used is also an adhesive agent that possesses no birefringence).

It is understood that method of manufacturing a 3D image display body may be modified in a variety of ways which will become readily apparent to those skilled in the art of having the benefit of the teachings disclosed herein. All such modifications and variations of the illustrative embodiments thereof shall be deemed to be within the scope and spirit of the present invention as defined by the Claims to the invention appended hereto.

What is claimed is

1. A method for manufacturing a 3D image display body which is used to display 3D images in which right-eye image display parts and left-eye image display parts are mixed, said 3D image display body manufacturing method comprising:
a phase-difference film is disposed on a transparent support with an adhesive agent interposed,
specified portions of the above-mentioned phase-difference film are then cut away by means of an ultra-hard blade, so that a plurality of grooves that extend from one side of the phase-difference film to the other are formed side by side in the phase-difference film, and
a display member is then superimposed on or bonded to the phase-difference film.

2. A method for manufacturing a 3D image display body which is used to display 3D images in which right-eye image display parts and left-eye image display parts are mixed, said 3D image display body manufacturing method comprising
a laminated phase-difference film formed by laminating a TAC film or CAB film, that does not possess birefringence and a polycarbonate film or drawn PVA film, etc., that possesses birefringence is disposed on a transparent support with an adhesive agent interposed so that the TAC film, etc., is located on the side of the adhesive agent,
specified portions of the polycarbonate film, etc., in this laminated phase-difference film are then cut away by means of an ultra-hard blade, so that a plurality of grooves which extend from one side of the polycarbonate film, etc., to the other are formed side by side in the polycarbonate film, etc., and
a display member is then superimposed on or bonded to the polycarbonate film, etc.

3. The method of claim 1 or claim 2 wherein the grooves formed by removal of the film by means of an ultra-hard blade are filled with an appropriate synthetic resin.
